(19) United States
(12) Patent Application Publication
(10) Pub. No.: US 2012/0155326 A1
(43) Pub. Date: Jun. 21, 2012

(54) WIRELESS SENSOR NETWORK SYSTEM AND COMMUNICATION METHOD THEREOF

(75) Inventors: Tae Joon Park, Daejeon (KR); Hoyong Kang, Daejeon (KR); Wun-Cheol Jeong, Daejeon (KR); Chang Sub Shin, Daejeon (KR); Se Han Kim, Daejeon (KR); In Hwan Lee, Daejeon (KR); Cheol Sig Pyo, Daejeon (KR)

(73) Assignee: Electronics and Telecommunications Research Institute, Daejeon (KR)

(21) Appl. No.: 13/326,969

(22) Filed: Dec. 15, 2011

(30) Foreign Application Priority Data
Dec. 16, 2010 (KR) 10-2010-0129406
Jun. 30, 2011 (KR) 10-2011-0064863

(51) Int. Cl. H04W 16/00; H04W 84/12

(52) U.S. Cl. 370/254; 370/338

(57) ABSTRACT

In a wireless sensor network system including at least one sensor network, when a network message received from a sensor node of a sensor network corresponds to a predetermined service, the wireless sensor network system forms a wireless local area network (WLAN) overlay network which is based on a WLAN system within a service area at which the sensor node is located. Data corresponding to the predetermined service is transmitted and received through the WLAN overlay network.

### CROSS-REFERENCE TO RELATED APPLICATION

This application claims priority to and the benefit of Korean Patent Application No. 10-2010-0129406 and No. 10-2011-0064863 filed in the Korean Intellectual Property Office on Dec. 16, 2010 and Jun. 30, 2011, the entire contents of which are incorporated herein by reference.

### BACKGROUND OF THE INVENTION

(a) Field of the Invention

The present invention relates to a wireless sensor network. More particularly, the present invention relates to a wireless sensor network system that interlocks and communicates with a wireless local area network (WLAN) system, and a communication method thereof.

(b) Description of the Related Art

Most of wireless sensor networks are formed based on ZigBee that satisfies a low-power condition.

For a wireless communication service requiring reliability, a connection structure which is able to constitute a multipath network would be effective. In a ZigBee-based network which is optimized in a low-power local area network, however, it is not easy to satisfy this demand according to a radio channel environment.

In addition, the prior technique of the ZigBee-based network uses an operation mode such as Polling, which controls an active period to satisfy a demand for low-power, and thereby processing a service of an n event-driven type which operates only when an event occurs is inevitably delayed. As a result, applying a low-power characteristic according to a time limit for responding to an event may be restricted.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a wireless sensor network system in which a wireless local area network (WLAN) system is overlaid to provide effective communication, and a communication method thereof.

Also, the present invention has been made in an effort to provide a wireless sensor system and a communication method having an advantage of reducing a delay in processing an event.

An exemplary embodiment of the present invention provides a communication method in a wireless sensor network system including at least one sensor network. The communication method includes: receiving a message from a sensor node included in a sensor network; determining whether the message corresponds to a predetermined service; forming a wireless local area network (WLAN) overlay network based on a WLAN system of an area at which the sensor node is located when the message corresponds to the predetermined service; and processing data provided from the sensor node through the WLAN overlay network.

The forming includes: transmitting, by the wireless sensor network system, a request message for requesting a network address to a backbone network; receiving, by the wireless sensor network system, a response message in response to the request message from the backbone network; and transmitting, by the wireless sensor network system, the response message to a WLAN system of an area at which the sensor node is located to form the WLAN overlay network.

In this case, the processing of data includes: receiving, by a sensor node, a response message including an address allocated by the WLAN system; and transmitting/receiving, by a sensor node, data through the WLAN overlay network formed by the WLAN system, based on the address.

Another embodiment of the present invention provides a wireless sensor network system. The wireless sensor network system includes: a sensor network including a plurality of sensor nodes; and a local server that functions as a gateway between the sensor network and a backbone network and transports data, wherein the local server includes an overlay managing unit that forms a wireless local area network (WLAN) overlay network based on a WLAN system of an area at which the sensor node is located when a message from the sensor node corresponds to a predetermined service.

The overlay managing unit transmits a message for requesting a network address to the backbone network, receives a respond message including a network address from the backbone network, and transmits the respond message to the WLAN system of an area at which the sensor node is located so that the sensor node transmits and receives data based on the network address through the WLAN system.

In the exemplary embodiment of the present invention as shown above, the predetermined service may be a service of a check and process type that controls an active period and an inactive period. Also, the predetermined service may be a service of an event-driven type that processes data when an event occurs.

### BRIEF DESCRIPTION OF THE DRAWINGS

FIG. 1 shows a structure of a wireless sensor network according to an exemplary embodiment of the present invention.

FIG. 2 shows an example of a logical structure of a data transfer network in a wireless sensor network according to an exemplary embodiment of the present invention.

FIG. 3 shows an example of transferring data by using a wireless local area network overlay network in the structure of FIG. 2.

FIG. 4 shows an example of transferring data in a general sensor network.

FIG. 5 shows a format of a network message according to an exemplary embodiment of the present invention.

FIG. 6 shows a flowchart of a communication method in a wireless sensor network system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

A wireless sensor network system and a communication method thereof according to an exemplary embodiment of the present invention will now be described.

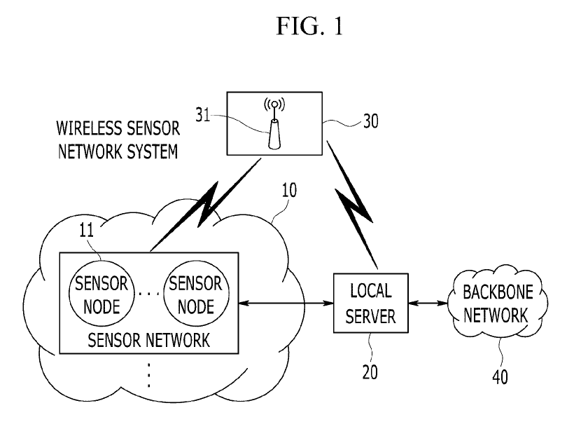

FIG. 1 shows a structure of a wireless sensor network system according to an exemplary embodiment of the present invention.

As shown in FIG. 1, a wireless sensor network system 1 according to an exemplary embodiment of the present invention includes at least one sensor network 10 and at least one local server 20. The sensor network 10 and the local server 20 are connected to a wireless local area network (WLAN) system 30.

At least one sensor network 10 is located in a service area of the WLAN system 30, and the sensor network 10 is connected to a backbone network 40 through the local server 20.

The sensor network 10 includes a plurality of sensor nodes. Each sensor node is a wireless access device having a ZigBee access function for accessing the sensor network 10, and a WLAN access function.

A sensor node among the plurality of sensor nodes included in the sensor network 10 may function as a sink node. The sink node may collect and process data transmitted from the others sensor nodes and transmit them to the local server 20.

The sensor nodes collect sensing data such as data related to a corresponding local environment and transmit the sensing data based on a ZigBee-based protocol.

For this purpose, the sensor node 20 processes and transmits data based on a method selected from among a first modulation method for WLAN-based communication and a second modulation method for ZigBee-based communication.

As examples, direct sequence spread spectrum (DSSS)/different binary phase shift keying (DBPSK) and DSSS/differential quadrature phase shift keying (DBPSK), which have a minimum data rate and are provided from techniques related to a WLAN, are similar to DSSS/offset quadrature phase shift keying (OQPSK) in hardware.

A physical layer of the sensor node 11 according to an exemplary embodiment of the present invention may be constituted as a type using two different modulation methods.

The illustrated modulation methods are partly different in back-off parameters, while a carrier sense multiple access with collision avoidance (CSMA/CA)-based media access control (MAC) may be used in both of them. Accordingly, it is possible to easily embody a sensor node by selecting one between the two modulation methods with the same engine.

A sink node requests sensor nodes to perform a sensing task of collecting sensing data, collects and processes sensing data from the sensor nodes, and communicates with the local server 20.

Herein, an additional server functioning as a gateway is used, but it is possible that a sink node that functions as a gateway may be used instead of the additional server in a sensor network.

In an exemplary embodiment of the present invention, the local server 20 may be an external server that is embodied as distinct from a sink node, or may be a sink node.

The local server 20 functions as a gateway for communicating with a remote server 41 located in the backbone network 40, transmitting data from the sensor network to the backbone network 40, and transmitting data from the backbone network 40 to the sensor network.

For example, when an external network is the IP-based Internet, the local server 20 may function as a gateway for inter-converting protocols between the sensor network and the Internet (e.g., conversion between an Internet protocol and a sensor network protocol and protocol conversion between a MAC and a PHY) to transmit/receive data.

Also, when providing a service, the local server 20 may constitute an overlay network with the WLAN system 40 to form a multipath network and manage the overlay network for bypass communication via the multipath network.

For this purpose, the local server 20 includes a gateway managing unit 21 that interlock the sensor network 10 with an external network such as the backbone network 40, and further includes an overlay managing unit 22 that forms a WLAN overlay network by connecting the sensor network to the WLAN system 30 when a predetermined service is provided.

The local server 20 according to an exemplary embodiment of the present invention, however, is not restricted thereto. That is, it is not restricted for the local server 20 to include the overlay network managing unit 22 and the local server 20 may be embodied as a type of including the gateway managing unit 21 without the overlay network managing unit 22

The Networking from which a protocol for using a WLAN overlay is excluded and the upper layer of the networking may function as a sensor network.

In an exemplary embodiment of the present invention, forming a WLAN overlay network may be performed in the local server 20 as well as the remote server 41 of the backbone network 40. In addition, when there are a plurality of local servers, a local server may be embodied to perform a function for managing a WLAN overlay network and another local server may be embodied to not perform the function.

The WLAN system 30 forms a WLAN overlay network by interlocking with the sensor network 10 and the local server 20, and includes an access point 31 for this purpose.

The WLAN overlay network may be used as a path for bypass communication or a path for processing an event in the wireless sensor network system 1 of the exemplary embodiment of the present invention.

For this, the access point 31 of the WLAN system 30 may include a function for managing an overlay network.

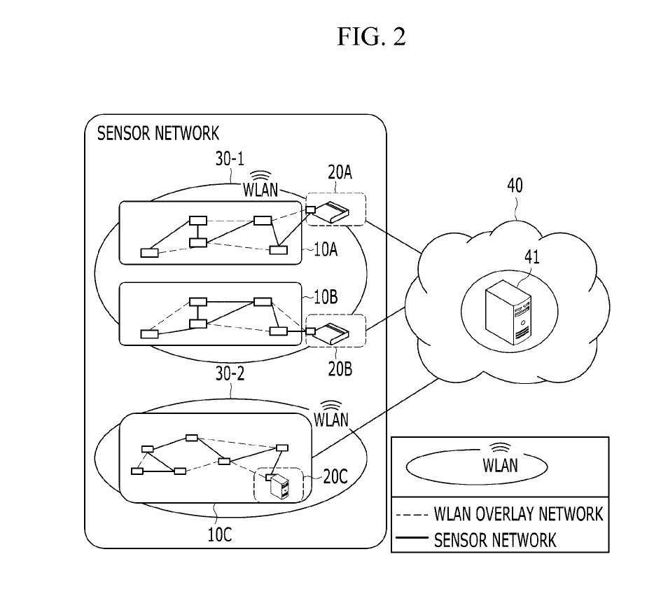

FIG. 2 shows a logical structure of a data transfer network in the wireless sensor network system 1 according to an exemplary embodiment of the present invention.

In the wireless sensor network system 1 according to an exemplary embodiment of the present invention, as shown in FIG. 2, a plurality of sensor networks 10A, 10B, and 10C are located at service areas of different WLAN systems 30-1 and 30-2, and each of the plurality of sensor networks 10A, 10B, and 10C is connected to the backbone network 40 through a corresponding local server (20A, 20C, or 20C).

For example, a first sensor network 10A and a second sensor network 10B are located at a service area of a WLAN system 30-1 (e.g., a Wi-Fi zone) and connected to the backbone network 40 through each of the local servers 20A and 20B.

The third sensor network 13 is located at a service area of another WLAN system 30-2 and is connected to the backbone system 40 through a corresponding local server 20C.

Herein, the third sensor network 13 may be a home sensor network and the local server 20C may be a home server of the home sensor network.

Under this network environment, sensor nodes constituting each sensor network, as shown in FIG. 2, form a sensor network and further form a WLAN overlay network though a WLAN.

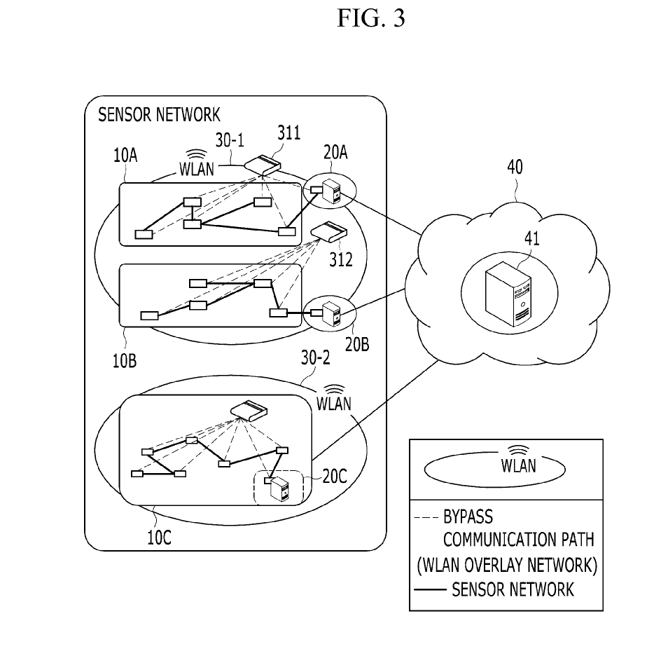

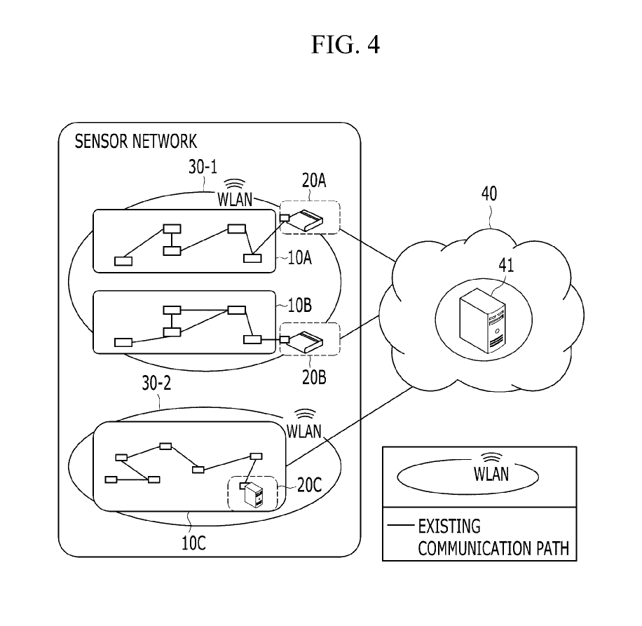

FIG. 3 shows an example of transferring data by using a WLAN overlay network in the structure of FIG. 2, and FIG. 4 shows an example of transferring data in a general sensor network.

In the WLAN sensor network system 1, each sensor node controls an active state and an inactive state of a wireless transmitter and a wireless receiver (not shown), and controls, for low power consumption, the wireless transmitter and the wireless receiver to transmit and receive in the active state.

Particularly, a sensor node transmits a polling request to a sink node according to a predetermined period, and the sink node transmits data to the sensor node in response to the polling request.

For a first service of a check and process type that controls an active period and an inactive period, a WLAN overlay network is formed, and thus data for the first service is transmitted/received through the WLAN overlay network. In addition, for a second service of an event-driven type that processes corresponding data when an event occurs, another WLAN overlay network may be formed and data for the second service is transmitted/received through the WLAN overlay network.

In this case, the data for second service is processed according to the sequence of events, and thereby an urgent task may not be processed prior to a present task to be processed according to the sequence. As a result, a delay in processing the urgent task may increase.

Accordingly, when data for the second service occurs, a WLAN overlay network may be formed so that the data is processed through the WLAN overlay network.

When forming a WLAN overlay network, as shown in FIG. 3, sensor nodes or local servers 20A, 20B, and 20C in sensor networks 10A, 10B, and 10C may be connected to the formed WLAN overlay network. The WLAN overlay network is formed by interlocking with a WLAN system (30-1 or 30-2) corresponding to an area in which a sensor network is located.

For example, each sensor node of the first sensor network 10A is connected to an access point 311 of a WLAN system 30-1 and uses a WLAN overlay network. The local server 20A of the first sensor network 10A is also connected to the access point 311 of the WLAN system 30-1 and uses the WLAN overlay network.

In addition, each sensor node of the second sensor network 12 is connected to an access point 312 of the WLAN system 30-1 and uses a WLAN overlay network. The local server 20B of the second sensor network 10B is also connected to the access point 312 of the WLAN system 30-1 and uses the WLAN overlay network.

These WLAN overlay networks function as a bypass communication path that is distinct from a path through which data is transmitted in a sensor network (hereinafter, this is referred to as an existing communication path).

Meanwhile, in a prior sensor network, as shown in FIG. 4, existing communication paths are only formed for the sensor networks 10A, 10B, and 10C and the local servers 20A, 20B, and 20C, and thus data is transmitted/received through the existing communication paths formed by sensor nodes in the prior sensor network.

Accordingly, when the first service or the second service occurs, time delay in transmitting/receiving data of a corresponding service may occur.

In this case, further to the existing communication paths shown in FIG. 4, another communication path can be formed by sensor nodes. However, the other communication path is formed to pass other sensor nodes in the same sensor network, and thereby time delay in processing the first service or the second service may occur.

According to the exemplary embodiment of the present invention, when data for the first service or the second service occurs, the data can be transmitted/received through a bypass communication path of a WLAN overlay network instead of an existing communication path in a sensor network.

The WLAN overlay network can be used as a path for transmitting information of a ZigBee interval in a sensor network, and thereby data can be transmitted/received without time delay.

For the transmitting/receiving data through a WLAN overlay network as described above, a network address may be allocated to a sensor node based on a network protocol, for example, an address resolution protocol (ARP) or a dynamic host configuration protocol (DHCP), in an exemplary embodiment of the present invention.

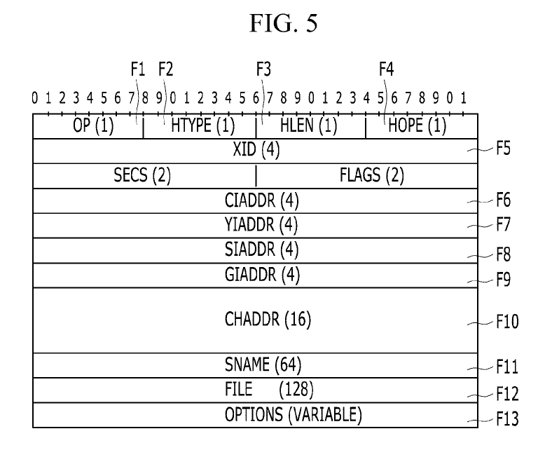

For example, when a network address is allocated based on the DHCP to form a WLAN overlay network, a message as shown in FIG. 5 may be used.

FIG. 5 shows a format of a network message according to an exemplary embodiment of the present invention.

When using a network message based on the DHCP, the network message includes an operation code field F1, a hardware type field F2, a hardware length field F3, a hop count field F4, a transaction ID field F5, a client address field F6, an allocation address field F7, a source address field F8, a gateway address field F9, a client MAC address field F10, a server name field F11, a file information field F12, and an option field F13.

In an exemplary embodiment of the present invention, an overlay node included in a WLAN overlay network uses the hardware type field F2 or the option field F13 in order to indicate that the overlay node is used for transmitting information on a sensor network while maintaining compatibility with a network using a WLAN.

When using the hardware type field F2, a value that is not allocated as yet is predetermined to indicate a sensor node that functions as an overlay node of a WLAN overlay network, and the predetermined value is written in the hardware type field F2.

For example, when there are values of 0-255, it is assumed that 0-37 are previously allocated as type values for the hardware type field F2 and 38-255 are not allocated.

In this case, according to an exemplary embodiment of the present invention, a value among 38-255 is predetermined to indicate a sensor node constituting a WLAN overlay network and the predetermined value is written in the hardware type field F2 of a network message. Therefore, the network message is represented as information on the sensor node constituting the WLAN overlay network of the network message.

Meanwhile, the option field F13 can be used instead of the hardware type field F2. The option field F13 includes an option code, an option length, and option data.

The DHCP corresponds to the extended concept of a bootstrap protocol (BOOTP). The part of the message shown in FIG. 5, except for the option field F13, will be referred as “a DHCP header”, and some bites that correspond to the last part of the DHCP header will be referred as “a magic cookie” or “a magic number”.

A predetermined value, for example, “99, 130, 83, 99”, can be allocated to the magic cookie to represent that a network message is a DHCP-based message.

In this case, the reception side determines that a received network message is not a BOOTP-based message, but is a DHCP-based message, based on the magic cookie included in the received message, and processes the option field F13 following the magic cookie.

Based on this, in an exemplary embodiment of the present invention, a predetermined value, for example “156, 125, 172, 156” is written in a magic cookie of a network message so that the network includes information on a sensor node of a sensor network and the information is stored in an option field following the magic cookie.

As shown above, by using a hardware type field F2 or an option field F13 of a network message based on a DHCP, it can be represented that the network message includes information on a sensor node of a sensor network. The information includes information on neighboring nodes for forming a bypass communication path.

In addition, the information on a sensor node of a sensor network includes information on a node for terminating the second service when the second service of an event-driven type is processed.

When processing the second event-driven type, there are many cases in which transmission and processing of sensor information is required to be rapidly performed.

In these cases, the information on a sensor node of a sensor network may include an address of a destination, a path, a processing method, and other information.

Meanwhile, the local server 20 that has a function for managing an overlay network according to an exemplary embodiment of the present invention performs a gateway function and a DHCP-based function for an overlay network.

Since the DHCP is compatible with the standard of wireless communication, the DHCP-based function does not need to be included in the local server 20 or a local server of each sensor network.

A communication method in a wireless sensor network system according to an exemplary embodiment of the present invention will now be described.

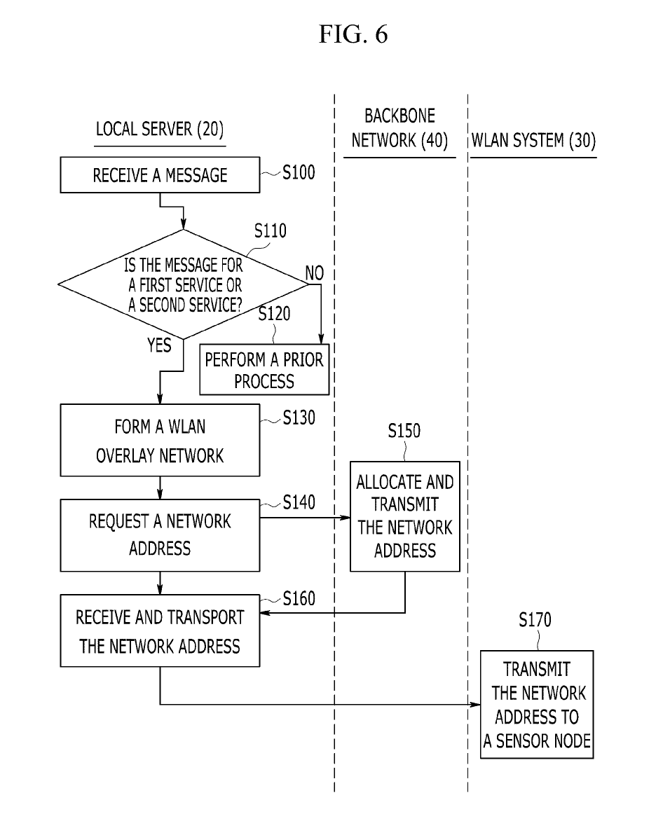

FIG. 6 shows a flowchart of a communication method in a wireless sensor network system according to an exemplary embodiment of the present invention.

When a sensing data request from a use terminal on an IP-based external network is input, the sensing data request is transmitted to a sensor network of an area related to the sensing data request or all sensor networks related to the sensing data request through the backbone network 40.

Also, a data request generated from a sensor network may be transmitted to another sensor network through a local server corresponding to the local server that generates the data request. In addition, a polling request from a sensor node of a sensor network to transport data is transmitted to a corresponding local server.

When a local server 20 receives a sensing data request, a data request, or a polling request through the backbone network 40 as shown above, the local server 20 performs a process for responding to the received request.

Specifically, when a message related to the request is received, the local server 20 determines whether the request corresponds to the first service or the second service according to an exemplary embodiment of the present invention (S100 and S110).

When the request does not correspond to the first service or the second service, the local server 20 performs a prior process for responding to the request (S120).

For example, the local server 20 selects a sensor node to provide sensing data based on mapping information on sensor nodes and requests sensing data from the selected sensor node, and then the local server 20 transmits the sensing data from the selected sensor node to the backbone network 40 so that the sensing data is transferred to the user terminal.

Meanwhile, when the request corresponds to the first service or the second service, the local server 20 forms a WLAN overlay network to process the request corresponding to the first service or the second service (S130).

The WLAN overlay network is used as a bypass communication path for the first service or an event processing path for the second service.

For this purpose, the local server 20 transmits a network message to the backbone network 40 to request a network address, wherein the network message includes a hardware type field F2 or an option field F13 that includes information on a sensor node of a sensor network (S140).

When receiving, from the backbone network 40, a response message having a network address in response to the network message (S150), the local server 20 transmits the response message to a WLAN system 30 that manages an area in which a sensor node 11 requesting the first service or the second service is included.

Accordingly, a WLAN overlay network through the WLAN system 30 is formed (S170).

The WLAN system 30 transmits the response message to a corresponding sensor node 11, and the sensor node 11 performs an operation based on the network address included in the response message.

That is, the sensor node 11 is provided with data related to the first service through the WLAN system 30, on the basis of the network address included in the response message.

As shown above, the WLAN overlay work is used as the bypass communication path when processing of data for the first service on the sensor network is required, so that a sensor node transmits the data through the WLAN overlay network.

Also, the WLAN overlay work may be used as the event processing path when processing of data for the second service on the sensor network is required, so that the data can be processed through the WLAN overlay network, regardless of the order in which the event occurs. Accordingly, it is possible to reduce the delay in processing events.

According to these exemplary embodiments of the present invention, a wireless sensor network system in which ZigBee-based wireless sensor network and a WLAN system coexist is formed. As a result, it is possible to constitute a multi-path network that effectively handles unusual situations.

Also, a service of an event processing type can be effectively handled by using the WLAN system that has a hot standby characteristic.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A communication method of a wireless sensor network system including at least one sensor network, the communication method including:
receiving a message from a sensor node included in a sensor network;
determining whether the message corresponds to a predetermined service;
forming a wireless local area network (WLAN) overlay network based on a WLAN system of an area at which the sensor node is located when the message corresponds to the predetermined service; and
processing data provided from the sensor node through the WLAN overlay network.

2. The communication method of claim 1, wherein the forming includes:
transmitting, by the wireless sensor network system, a request message for requesting a network address to a backbone network;
receiving, by the wireless sensor network system, a response message in response to the request message from the backbone network; and
transmitting, by the wireless sensor network system, the response message to a WLAN system of an area at which the sensor node is located to form the WLAN overlay network.

3. The communication method of claim 2, wherein the processing of data includes:
receiving, by a sensor node, a response message including an address allocated by the WLAN system; and
transmitting/receiving, by a sensor node, data through the WLAN overlay network formed by the WLAN system, based on the address.

4. The communication method of claim 2, wherein the request message is a dynamic host configuration protocol (DHCP)-based message including a hardware type field and an option field.

5. The communication method of claim 4, further including
selecting a value that has not been allocated from among a plurality of values to be written in the hardware type field and representing that the request message includes information on a sensor node of a sensor network by using the selected value.

6. The communication method of claim 4, further including,
when fields except for the option field among fields included in the request message are set as a header, writing a value representing that the request message is related with a sensor node in a magic cookie that is located at the last part of the header.

7. The communication method of claim 1, wherein the predetermined service is a service of a check and process type that controls an active period and an inactive period.

8. The communication method of claim 1, wherein the predetermined service is a service of an event-driven type that processes data when an event occurs.

9. A wireless sensor network system includes:
a sensor network including a plurality of sensor nodes; and
a local server that functions as a gateway between the sensor network and a backbone network and transports data,
wherein the local server includes an overlay managing unit that forms a wireless local area network (WLAN) overlay network based on a WLAN system of an area at which the sensor node is located when a message from the sensor node corresponds to a predetermined service.

10. The wireless sensor network system of claim 9, wherein the overlay managing unit transmits a message for requesting a network address to the backbone network, receives a respond message including a network address from the backbone network, and transmits the respond message to the WLAN system of an area at which the sensor node is located so that the sensor node transmits and receives data based on the network address through the WLAN system.

11. The wireless sensor network system of claim 10, wherein the request message is a dynamic host configuration protocol (DHCP)-based message including a hardware type field, and
a value that has not been allocated, among a plurality of values to be written in the hardware type field, is written in the hardware type field to represent that the request message includes information on a sensor node of a sensor network.

12. The wireless sensor network system of claim 10, wherein the request message is a dynamic host configuration protocol (DHCP)-based message including an option field, and fields except for the option field among fields included in the request message are set as a header,
wherein a value representing that the request message is related with a sensor node is written in a magic cookie that is located at the last part of the header.

13. The wireless sensor network system of claim 9, wherein the predetermined service is a service of a check and process type that controls an active period and an inactive period, and
the WLAN overlay network is used as a bypass communication path for the service.

14. The wireless sensor network system of claim 9, wherein the predetermined service is a service of an event-driven type that processes data when an event occurs, and
the WLAN overlay network is used as an event processing path for the service.

15. The wireless sensor network system of claim 9, wherein the sensor node is a wireless accessing device that has a function for accessing a ZigBee and a function for accessing a WLAN.
